(19) United States
(12) Patent Application Publication
(10) Pub. No.: US 2023/0139860 A1
(43) Pub. Date: May 4, 2023

(54) PHARMACEUTICAL CONTAINER PROCESSING SYSTEMS AND METHODS

(71) Applicant: Express Scripts Strategic Development, Inc., St. Louis, MO (US)

(72) Inventor: Gabriel Di Genova, Wildwood, MO (US)

(21) Appl. No.: 17/975,260

(22) Filed: Oct. 27, 2022

Related U.S. Application Data
(60) Provisional application No. 63/273,002, filed on Oct. 28, 2021.

(51) Int. Cl. B65C 9/06; B65C 9/40; B65C 9/04; B65C 9/26; B65C 3/08

(52) U.S. Cl. CPC B65C 9/06; B65C 9/40; B65C 9/04; B65C 9/26; B65C 3/08

(57) ABSTRACT

A pharmaceutical container processor for a pharmaceutical container, components thereof, and associated methods. The pharmaceutical container includes a container body and a preexisting label on the container body. The preexisting label has opposite side edges defining a preexisting label gap therebetween. The pharmaceutical container processor includes a label holder, a label detector, and a container transporter. The label holder positions a patient label to be applied on the container body of the pharmaceutical container. The label detector detects the preexisting label on the container body. The container transporter orients the preexisting label on the container body of the pharmaceutical container relative to the label holder so that at least a portion of the preexisting label gap is uncovered by the patient label when the patient label is applied on the container body.

### CROSS-REFERENCE TO RELATED APPLICATION

The present application claims priority to U.S. Provisional Application No. 63/273,002, filed on Oct. 28, 2021, the entirety of which is hereby incorporated by reference.

### FIELD

The present disclosure generally relates to pharmaceutical container processing systems, and more particularly to pharmaceutical container processing systems that apply labels to pharmaceutical containers.

### BACKGROUND

High volume pharmacies process and fulfill a large number of prescription orders per day. These pharmacies often rely on automated systems to process, fill, and pack one or more prescriptions together for delivery to a patient. These automated systems generally fit into one of two categories: (1) systems, such as high-volume fillers, that automatically fill pharmaceutical containers (e.g., auto-filled containers) with specific quantities of pharmaceuticals; and (2) systems, such as unit-of-use systems, that process unit-of-use products or containers. A unit-of-use container contains an entire prescription of a pharmaceutical and can therefore be sent to the patient without modifying the pharmaceutical(s) (e.g., the quantity, type, etc.) in the container and without product packaging modification (or with minimal product packaging modification) except for labeling with patient information (e.g., applying a patient label). Unit-of-use products can include a full course of medicine to be taken by a patient, for example, an entire prescription (e.g., a thirty-day supply, a sixty-day supply, or a ninety-day supply). The unit-of-use products contain known quantities of medication in containers that are closed and sealed by, for example, the pharmaceutical manufacturer. These unit-of-use products frequently have a preexisting label on the container that is applied by the pharmaceutical manufacturer.

### SUMMARY

In one aspect, a pharmaceutical container processor for processing a pharmaceutical container is disclosed. The pharmaceutical container includes a container body and a preexisting label on the container body. In an example embodiment, the container body is cylindrical. In an example embodiment, the container body is a rectangular box or a parallelepiped. The preexisting label has opposite side edges defining a preexisting label gap therebetween. The pharmaceutical container processor comprises a label holder configured to position a patient label to be applied on the container body of the pharmaceutical container. A label detector is configured to detect the preexisting label on the container body, e.g., orientation, skew and vertical position. A container transporter is configured to orient the preexisting label on the container body of the pharmaceutical container relative to the label holder so that at least a portion of the preexisting label gap is uncovered by the patient label when the patient label is applied on the container body.

In another aspect, a method of processing a pharmaceutical container comprises orienting the pharmaceutical container and a patient label relative to one another. The pharmaceutical container includes a container body and a preexisting label on the container body. The preexisting label has opposite side edges defining a preexisting label gap therebetween. The method also comprises applying the patient label on the container body of the pharmaceutical container so that at least a portion of the preexisting label gap is uncovered by the patient label. The preexisting label gap coincides, at least partially with, a patient label gap created by the applied patient label.

In another aspect, a pharmaceutical container processor for processing a pharmaceutical container is disclosed. The pharmaceutical container includes a container body and a preexisting label on the container body. The preexisting label has opposite side edges defining a preexisting label gap therebetween. The pharmaceutical container processor comprises a container repository configured to hold the pharmaceutical container. A labeler is configured to apply a patient label on the container body of the pharmaceutical container so that at least a portion of the preexisting label gap is uncovered by the patient label. A container transporter is configured to move the pharmaceutical container from the container repository to the labeler.

In another aspect, a method of processing a pharmaceutical container comprises moving the pharmaceutical container to a labeler. The pharmaceutical container includes a container body and a preexisting label on the container body. The preexisting label has opposite side edges defining a preexisting label gap therebetween. The method also comprises applying, with the labeler, a patient label on the container body of the pharmaceutical container so that at least a portion of the preexisting label gap is uncovered by the patient label.

Other objects and features will be in part apparent and in part pointed out hereinafter.

### BRIEF DESCRIPTION OF THE DRAWINGS

FIG. 1 is a perspective of a pharmaceutical container;

FIG. 2 is a perspective of a pharmaceutical container processing system according to one embodiment of the present disclosure;

FIG. 3 is a perspective of a container repository of the pharmaceutical container processing system;

FIG. 4 is a perspective of a labeler of the pharmaceutical container processing system;

FIG. 5 is a perspective of a container transporter of the pharmaceutical container processing grabbing a pharmaceutical container from the container repository;

FIG. 6 is a perspective of the container transporter positioning the pharmaceutical container at the labeler;

FIG. 7 is a perspective of the container transporter positioning the pharmaceutical container to verify the applied patient label;

FIG. 8 is a perspective of the pharmaceutical container with the patient label applied thereon; and

FIG. 9 is a schematic diagram of an example control system for the pharmaceutical container processing system.

Corresponding reference characters indicate corresponding parts throughout the drawings.

### DETAILED DESCRIPTION

Referring to the figures, a pharmaceutical container processing system (e.g., pharmaceutical container processor or pharmaceutical container placer) according to one embodiment of the present disclosure is indicated generally by reference numeral 10. The pharmaceutical container processing system 10 illustrated and described by the present disclosure is an example system and it is understood that pharmaceutical container processing systems of other configurations are within the scope of the present disclosure. The pharmaceutical container processing system 10 processes prescription orders received by the system. A prescription order may include one or more pharmaceuticals (e.g., prescription drugs), which are contained in pharmaceutical containers C. The illustrated pharmaceutical containers C are in form of round and rectangular (e.g., square) bottles, although it is understood the pharmaceutical containers may have other forms such as a box or any other suitable container. The container C may have an opening through which a medicine or other item to be stored in the interior of the container is inserted into the interior of the container, which is defined by a main body of the container. A closure (e.g., cap) closes the opening to secure the item in the interior of the container C. A label can be placed on the outer wall of the main body of the container away from the closure or opening. The pharmaceutical container processing system 10 comprises a unit-of-use system that processes pharmaceutical containers C that are unit-of-use products. The pharmaceutical container processing system 10 generally stores, labels, and dispenses the unit-of-use pharmaceutical containers C. However, the pharmaceutical container processing system 10 may also be used with non-unit-of-use systems, such as a high-volume pharmaceutical order processing system (e.g., a high-volume filler). Further details on pharmaceutical order processing systems and components thereof, including unit-of-use systems, may be found in U.S. Pat. Nos. 9,373,065, 9,697,335, 9,944,419, 9,978,036, and 10,053,248, the entireties of which are hereby incorporated by reference. However, it will be appreciated that the systems and components disclosed herein can be used in other contexts without departing from the scope of the present disclosure.

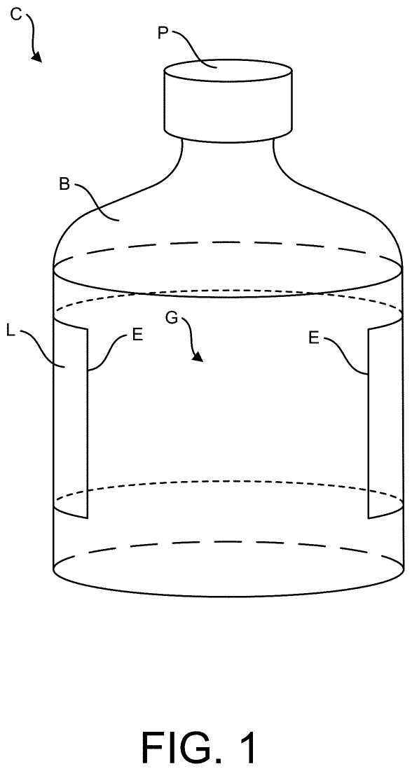

Referring to FIG. 1, an exemplary pharmaceutical container C is shown. The pharmaceutical container C includes a container body B and a cap P. The container body B defines an interior volume to hold the pharmaceutical. An opening is formed in the container body B through which an item, e.g., the pharmaceutical, can be inserted into the interior volume formed by the container body B. The cap P can close the opening to fully enclose the item in the interior of the container body B. The item to be stored or the pharmaceutical may be in the form of a liquid or solid (e.g., pills, tablets, gel caps or the like). The illustrated container body B is round (e.g., cylindrical), although the container body may have other shapes such as rectangular (e.g., parallelepiped shapes or boxes). The pharmaceutical container C includes a preexisting label L on the container body B. The preexisting label L is a label applied to the container body B before the pharmaceutical container is loaded into the system 10. Typically, the preexisting label L will be a pharmaceutical manufacturers label applied by the manufacturer of the pharmaceutical, although preexisting label L may come from other sources. In an example, the preexisting label is on the container body B before it is in the pharmacy for fulfilling pharmaceutical orders. The preexisting label L does not extend around the entire circumference or perimeter of the container body B. For example, the container body B has an exterior distance around its outer wall that is longer than the length of the preexisting label L. The leading edge of the preexisting label L and trailing edge of the preexisting label do not overlap when applied to the container body B. This allows a person or patient to look into the container body B through the gap G. The container body B is typically semi-transparent or transparent, to see the item, items or pharmaceutical within the container body without the preexisting label L blocking the sight as the label is typically opaque, e.g., a label that is printed and includes an adhesive layer to secure the label L to the outer wall of the container body B. This permits a person to quickly determine how full or empty the container body B is of the pharmaceutical. The person may then use this information to determine when a new prescription needs to be ordered, for example. The preexisting label L is not transparent and blocks the person from viewing the inside of the container body B. The preexisting label L has opposite side edges E. The side edges E are spaced apart from each other, thereby defining a preexisting label gap G therebetween. The person looks through the portion of the container body B aligned with the preexisting label gap G (e.g., the portion of the container body not blocked by the preexisting label L) to view the pharmaceutical inside the container body.

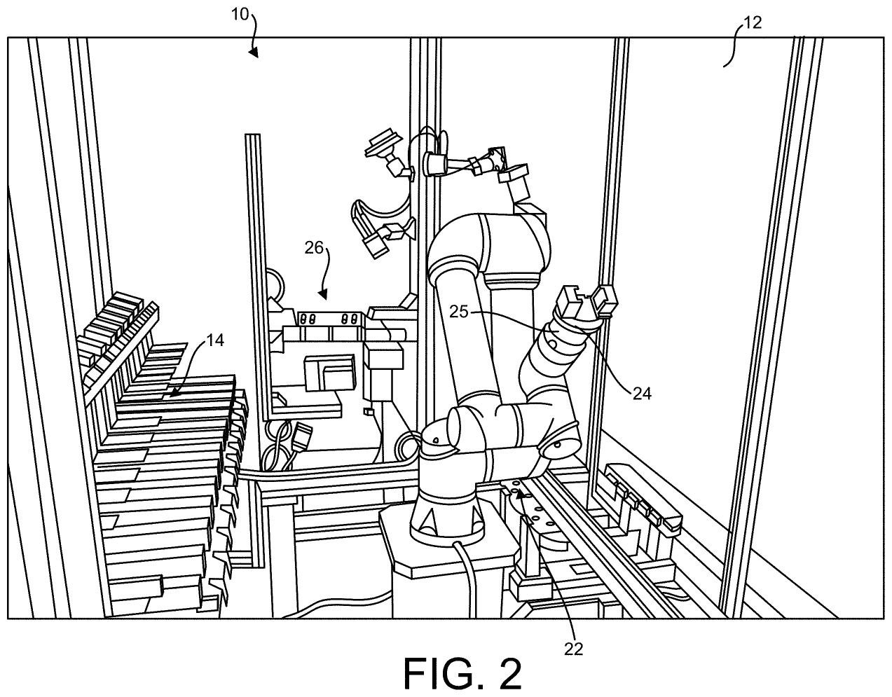

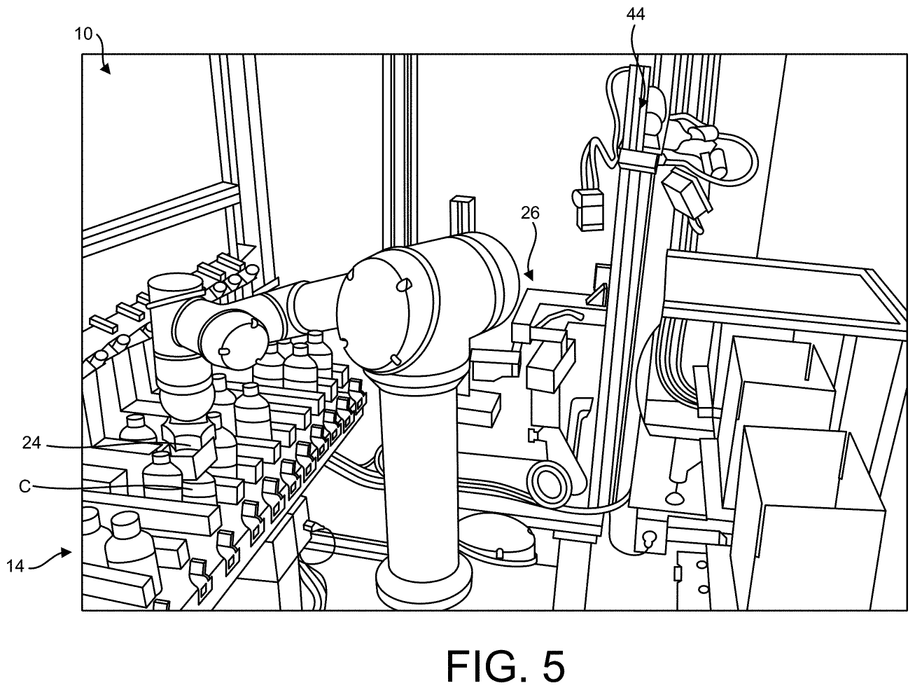

Referring to FIGS. 2-7, the pharmaceutical container processing system 10 (e.g., system) processes the pharmaceutical containers C (e.g., a plurality of pharmaceutical containers) to fill prescription orders. To process the plurality of pharmaceutical containers C, the system 10 includes a set of container operation stations (described in more detail below) along which a set of container operations occur. Broadly, a station is where one or more operations (e.g., functions) occur to further the processing of the pharmaceutical containers C to fill a prescription order and may include the one or more components that perform the one or more operations (i.e., the one or more components are at the station). The set of container operations may include one or more of storing, labeling, dispensing, transporting, and/or verifying the pharmaceutical container C. Other container operations are also within the scope of the present disclosure. In addition, more than one container operation may occur at a container station. In the illustrated embodiment, the system 10 includes a storage station, a labeling station, an identification stations and a dispensing or outlet station. The system 10 may include more or less of each station as well as include stations other than described herein. Generally, the storage station, the labeling station, the identification station, and the outlet station are used to process the unit-of-use pharmaceutical containers C by storing, labeling, verifying, and dispensing the pharmaceutical containers to fill a prescription order received by the system 10. Accordingly, the system 10 is an automated system use to auto-fill or auto-process received prescription orders. The general movement of the pharmaceutical containers between these different stations is described below, although other paths of movements between the stations are within the scope of the present disclosure.

In general, the storage station is where the plurality of pharmaceutical containers C are stored. The labeling station is where a label (e.g., a patient specific label) is applied to the plurality of pharmaceutical containers C after the containers are removed from the storage station. The identification station is where the plurality of pharmaceutical containers C are each identified after the label is applied to the containers at the labeling station. The dispensing station is where the plurality of pharmaceutical containers C are moved to after the containers are identified at the identification station for further processing (broadly, to be dispensed) such as packaging or marrying with other containers. Generally, each pharmaceutical container C is moved, in order, through the storage station, the labeling station, the identification station and then the dispensing station.

The system 10 includes an enclosure 12. The enclosure 12 defines (e.g., encloses) a processing area. The set of container stations are generally disposed in the processing area such that the series of container operations takes place within the processing area (e.g., enclosure 12). The storage station, the labeling station, the identification station, and the dispensing station are at least partially disposed in the processing area. In the illustrated embodiment, the storage station, the labeling station, the identification station, and the dispensing station are all disposed entirely within the processing area. The enclosure 12 helps keep the processing area and components therein clean.

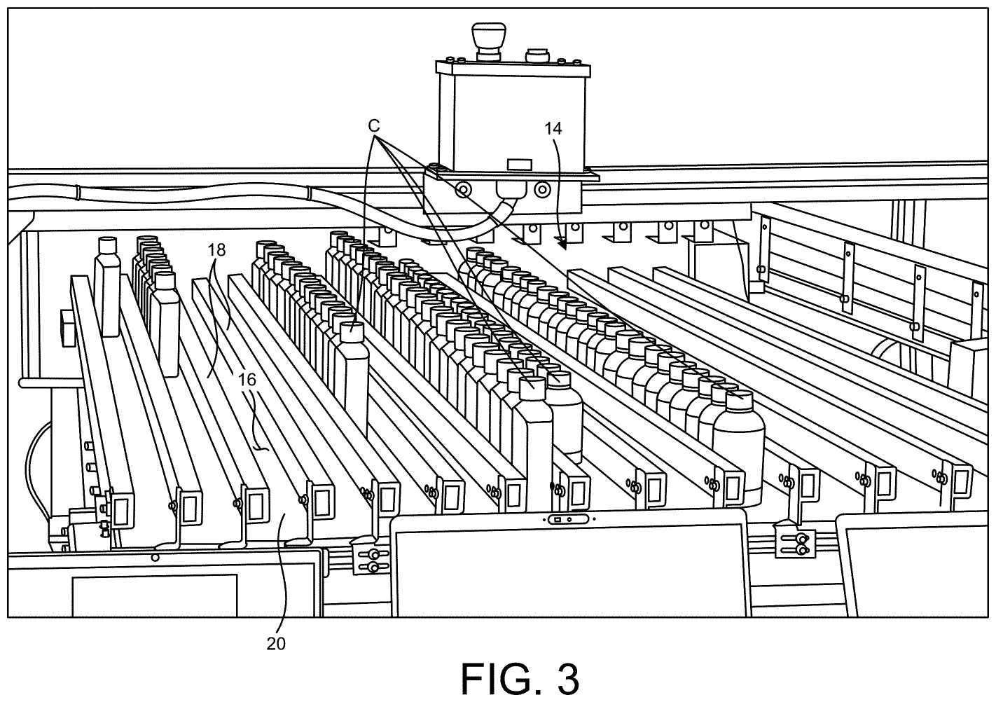

Referring to FIGS. 2 and 3, the system 10 includes a container repository 14 (broadly, at least one container repository) at the storage station (e.g., the container repository defines the storage station). The container repository 14 is configured to hold and store the pharmaceutical containers C. The container repository 14 receives and holds the pharmaceutical containers C and can hold many different types of pharmaceutical containers (e.g., types of pharmaceuticals). The container repository 14 can be configured to hold pharmaceutical containers C of different shapes and of generally any size. For example, the container repository 14 can be configured for bottles (round and/or rectangular), boxes and other shapes and any combination thereof. In the illustrated embodiment, the container repository 14 is arranged for round bottles and rectangular bottles. In one embodiment, the pharmaceutical containers C are manually loaded onto (e.g., into) the container repository 14 by an operator. The enclosure 12 can define an opening to permit the pharmaceutical containers C to be manually loaded by the operator. The enclosure 12 blocks off the area in which a container transporter (described in more detail below) will move to transfer the containers.

The container repository 14 includes a shelf or rack configured to support (e.g., hold) the pharmaceutical containers C. The rack includes a plurality of channels 16 sized and shaped so that the pharmaceutical containers C are arranged one after another (e.g., single file) in the channel. Desirably, the widths of the channels 16 are adjustable to configure the channels to different sizes of containers C. Opposite sides of the channels 16 are defined by guides or rails 18 which are preferably movable relative to one another to adjust the size (e.g., width) of the channel to conform to the size (e.g., width) of the pharmaceutical containers C placed therein. For example, the guides 18 can move toward or away from one another to increase or decrease the width of the channel 16. In operation, each channel 16 is filled with the same type of pharmaceutical containers C (e.g., all the pharmaceutical containers in the channel contain the same type and quantity of a pharmaceutical). The shelf or rack can define at least a portion of the enclosure with an entry side remote from the container transporter being open to load the containers at the entry side.

The rack includes a conveyor 20 that defines the platform supporting the pharmaceutical containers C (e.g., defines the base of the channels 16). A prime mover, such as an electric motor, is operatively coupled to the conveyor 20 for moving the conveyor and thereby the pharmaceutical containers C there on within the channels 16. The conveyor 20 moves the pharmaceutical containers C in the channel 16 toward a pick-up location located at the front of the container repository 14. Each pick-up location is generally at the forward end of each channel 16. The conveyor 20 moves the pharmaceutical containers C forward, toward (e.g., into) the pick-up location, where a container transporter 22 grabs the pharmaceutical containers (described in more detail below). Accordingly, as pharmaceutical containers C are removed from the pick-up locations, the conveyor 20 moves subsequent pharmaceutical containers into the pick-up positions. The rack may include a container sensor at each pick-up location. The container sensor is configured to detect the presence of a pharmaceutical container C at the pick-up location. The container sensor may comprise any suitable sensor for detecting the presence of a pharmaceutical container such as but not limited to a pressure sensitive switch or a proximity sensor (e.g., a photoelectric sensor). In one embodiment, the container sensors and the conveyors 20 operate as a closed-loop system, with the conveyor 20 operating (e.g., moving) automatically after a container sensor no longer detects the presence of a pharmaceutical container C and continuing to move until the container sensor detects the presence of a pharmaceutical container, at which point the conveyor stops. The rack may include a stop at the end of each channel 16 that engages a pharmaceutical container to position (e.g., stop and hold) the pharmaceutical container in the pick-up location. Other configurations of the container repository are within the scope of the present disclosure.

Referring to FIGS. 2 and 6-7, the system 10 includes a container transporter 22. Generally, the container transporter 22 is configured to move the pharmaceutical containers C through the operation stations. The container transporter 22 moves the pharmaceutical containers C from the storage station, through the label station and identification station and then to the dispensing station. In particular, the container transporter 22 grabs the pharmaceutical container C from the container repository 14 and carries the pharmaceutical container to the other stations and releases (e.g., dispenses) the pharmaceutical container at the dispensing station. In the illustrated embodiment, the container transporter 22 comprises a robot such as a six-axis robotic arm, although other robots are within the scope of the present disclosure. For example, the container transporter 22 may comprise a selective-compliance-articulated robotic arm, a cylindrical robot, a delta robot, a polar coordinate robot, a vertically articulated robot, a Cartesian coordinate robot or any other suitable device. The container transporter 22 includes a grabber 24 (broadly, end-of-arm tooling) configured to selectively grab and hold (e.g., carry) the pharmaceutical container C. The grabber 24 includes movable jaws for grabbing the cap P of the pharmaceutical container C. Other types of grabbers such as suction pads, suction bags (e.g., a bag with suction inlets and filled with beads that conforms to the shape of the container C) or any other suitable mechanism for gripping the pharmaceutical containers C are within the scope of the present disclosure. The grabber 24 grips the container C to move the container without covering the preexisting label L or the area on which the patient label will be applied. For example, the grabber 24 may grab the cap P of the container C. The grabber 24 (broadly, the container transporter 22) includes a rotational joint 25 that permits the grabber (specifically, the pharmaceutical container C held thereby) to rotate 360 degrees. Accordingly, the grabber 24 (broadly, the container transporter) is considered a container orienter because it orients the pharmaceutical container C relative to the patient label PL (as described in more detail herein). Broadly, a container orienter is any device that changes the orientation of a pharmaceutical container, preferably to a specific desired orientation.

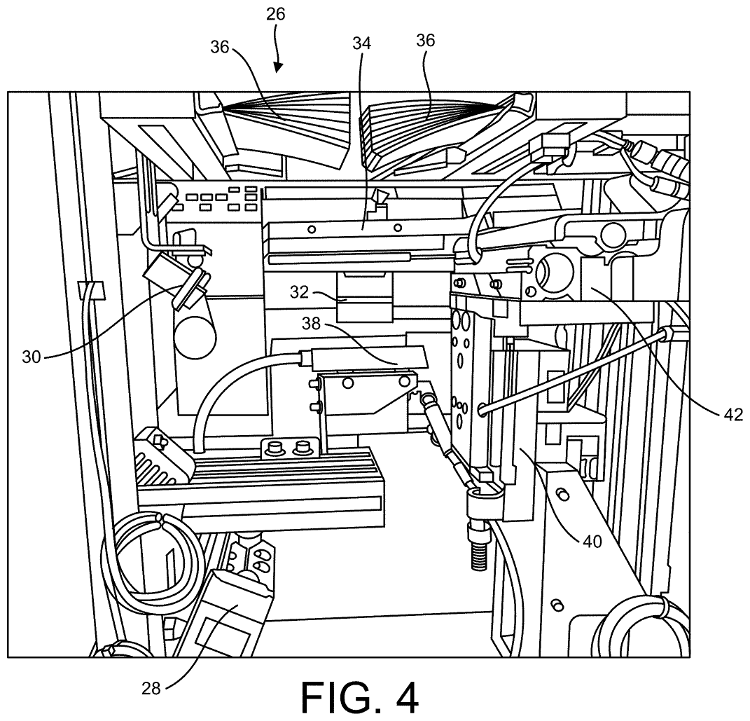

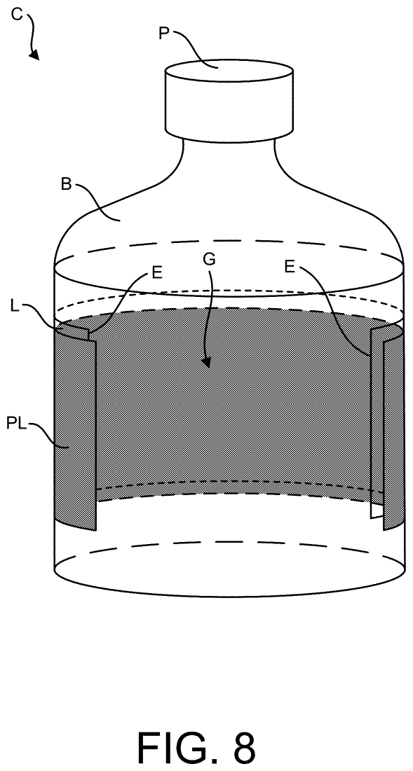

Referring to FIGS. 2 and 4, the system 10 includes a labeler 26 at the labeling station (e.g., the labeler defines the labeling station). The container transporter 22 moves the pharmaceutical container C from the container repository 14 to the labeler 26. The labeler 26 is configured to apply a label PL (e.g., a patient specific label) on the container body B of the pharmaceutical container C so that at least a portion of the preexisting label gap G is uncovered by the patient label, as shown in FIG. 8. In one embodiment, the patient label PL is applied on the container body B of the pharmaceutical container C so that the entirety of the preexisting label gap G is uncovered by the patient label. The patient label PL is not transparent. Accordingly, applying the patient label PL such that it does not cover the portion of the container body B aligned with the preexisting label gap G allows a person, such as a patient, to look into the container body to view the pharmaceutical contained therein. This allows a patient to quickly determine how empty the pharmaceutical container C is and plan accordingly, such as reordering the prescription at the appropriate time. If the patient label PL is applied such that is covers the preexisting label gap G, the combination of the patient label and the preexisting label L would completely surround the circumference or perimeter of the container body B, blocking the patient from being able to easily and quickly view the amount of pharmaceutical remaining in the container body from the side. This makes it difficult to determine how much of the pharmaceutical is left in the container body B. For example, the patient may have to tilt the pharmaceutical container C from its upright position in order to see into the container body, such as through the bottom thereof, but this can result in the pharmaceutical moving around in the bottle as well, making it difficult to determine the amount of the pharmaceutical remaining in the bottle. Preferably, the patient label PL is applied on the container body B so that the patient label does not extend across the preexisting label gap G. This arrangement maintains a continuous vertical segment of the preexisting label gap G, that extends from the top of the preexisting label gap to the bottom of the preexisting label gap, to allow the patient to look into the container body B to view the amount of pharmaceutical remaining (e.g., an upper end of the pharmaceutical liquid) regardless of the quantity of pharmaceutical remaining. If the patient label PL extends across the preexisting label gap G, the upper end of the pharmaceutical will only become visible through the top of the pharmaceutical container (when the container is in its upright position) for certain pharmaceutical amounts. To prevent the patient label PL from covering the preexisting label gap G, the patient label is applied generally over the preexisting label L (e.g., align the patient label with the preexisting label). Alignment the patient label PL over the preexisting label L maximizes the uncovered area of the preexisting label gap G (e.g., the patient label covers none or only a small amount of the preexisting label gap). As shown in FIG. 8, perfect alignment between the patient label PL and the preexisting label L, while desirable, is not required. The patient label PL can include patient health information and/or patient identifying information thereon, such as the patient's name, identification number, etc., as opposed to the preexisting label from the manufacturer which does not have this type of information.

Referring to FIG. 4, the labeler 26 includes a first or container identifier 28, a label detector 30, a printer 32, a label holder 34, two brushes 36, and a label mover or pusher 38. The container identifier 28 (e.g., a first container identifier) is configured to identify the pharmaceutical container C after the pharmaceutical container has been removed from the container repository 14 but before the patient label PL is applied. This way the system 10 can confirm the correct pharmaceutical container C was removed for the prescription order (e.g., confirm the pharmaceutical container with the correct type of prescription for the prescription order was selected). In the illustrated embodiment, the container identifier 28 scans or reads the preexisting label L of the pharmaceutical container C to identify the pharmaceutical container. The container identifier comprises a scanner or a reader, such as a barcode reader. The scanner or reader can read or scan a machine readable marking (e.g., a barcode, QR code, etc.) or an identification chip (e.g., a near field communication (NFC) chip, a radio frequency identification (RFID) tag, or other similar devices) on the pharmaceutical container C. By reading the machine readable marking or identification chip on the pharmaceutical container C, the identity or type of the pharmaceutical container can be verified or confirmed to ensure the correct pharmaceutical container was removed from the container repository 14. The scanner or reader may comprise a camera, a barcode scanner, identification tag reader (e.g., NFC reader, RFID reader, etc.) or any other suitable device. Other configurations of the container identifier are within the scope of the present disclosure. In this embodiment, the label station may be considered a label and identification station because the labeler 26 includes the container identifier 28. In other embodiments, the container identifier may be separate from the labeler and spaced from the labeler station, at its own identification station.

The label detector 30, generally, detects the preexisting label PL on the container body B of the pharmaceutical container C. The label detector 30 is used to determine the position and/or orientation of the preexisting label L. The label detector 30 is configured to detect or determine the position and/or orientation of the preexisting label L of the pharmaceutical container C (e.g., vertical position and skew of the preexisting label on the container). The label detector 30 can include imaging circuitry to detect the edges of the preexisting label L, e.g., top edge, bottom edge. The label detector 30 can also detect the leading edge and trailing edge of the preexisting label L. In particular, the label detector 30 detects or determines the position of the preexisting label L and the labeler 26 (specifically, the label holder 34 and, more specifically, the patient label PL held by the label holder) relative to one another. In one embodiment, the label detector 30 comprises a label orientation sensor configured to detect the orientation of the preexisting label L of the pharmaceutical container. In one embodiment, the label orientation sensor comprises a contrast sensor, such as a laser contrast sensor. In one embodiment, the label orientation sensor detects an edge (e.g., side edge E) (broadly, a reference point) of the preexisting label L. The label detector can be configured to detect other reference points of the preexisting label L. For example, the label detector can comprise a scanner or a reader, such as a barcode reader, that can reads or scans a machine readable marking or identification tag (e.g., RFID) (broadly, a reference point) of the preexisting label L. The position of the machine readable marking and/or identification tag relative to the rest of the preexisting label L is known based on the type of pharmaceutical container selected, and thus the position and/or orientation of the preexisting label can be extrapolated. Accordingly, in one embodiment, the label detector 30 and the first container identifier 28 may be implemented by a single device (e.g., a scanner or reader) that both identifies the pharmaceutical container C and determines the position and/or orientation of the preexisting label L on the pharmaceutical container.

The printer 32 prints the patient label PL. Once the patient label PL is printed, the patient label is moved to the label holder 34. The label holder 34 is configured to hold or position the patient label. In the illustrated embodiment, the label holder 34 comprises a vacuum or suction pad that holds the patient label PL. The vacuum pad is fluidly connected to a negative pressure source 50, such as a vacuum, that generates the suction needed to hold the patient label PL. The label pusher 38 is configured to direct or move the patient label PL to the label holder 34 after the patient label is printed. In the illustrated embodiment, the label pusher 38 comprises an air knife that directs a pressurized stream of air against the patient label PL to move the patient label toward the label holder 34 so that the label holder engages and holds the patient label. The label holder 34 is operatively connected to a first prime mover 40 (e.g., a linear actuator) and a second prime mover 42 (e.g., a linear actuator). The first prime mover 40 raises and lowers label holder 34 in order to remove a backing from the patient label PL. The patient label PL includes a pressure sensitive adhesive that is covered by the backing until the patient label is ready to be applied to the pharmaceutical container C. When the first prime mover 40 raises the label holder 34, the backing is removed from the patient label PL. The second prime mover 32 moves the label holder 34 generally horizontally (e.g., front to back). Together, the first and second prime movers 40, 42 move the label holder between a pick position and an application position. In the pick position, the label holder 34 is generally aligned with the area where the patient label PL is dispensed by the printer 32 such that the label holder is positioned to receive and hold the patient label PL when the patient label is moved by the label pusher 38. In the application position, the label holder 34 is positioned to allow the pharmaceutical container C to be moved into engagement with the patient label PL held by the label holder. In the application position, the label holder 34 is generally disposed directly below the brushes 36. The pick position is lower than and rearward of the application position. The brushes 36 are configured to push the patient label against the container body B as the container transporter 22 moves the pharmaceutical container C away from the labeler 26.

Generally, in operation, the pharmaceutical container C and the patient label PL are oriented relative to one another and then the patient label is applied on the container body B of the pharmaceutical container so that at least a portion of the preexisting label gap G is uncovered by the patient label. The container transporter 22 is configured to orient the preexisting label L on the container body B of the pharmaceutical container C relative to the label holder 34 so that at least a portion of the preexisting label gap G is uncovered by the patient label PL when the patient label is applied on the container body. In one embodiment, the container transporter 22 orients the preexisting label L on the container body B of the pharmaceutical container C relative to the label holder 34 so that the entirety of the preexisting label gap is uncovered by the patient label when the patient label is applied on the container body. The container transporter 22 orients the preexisting label L on the container body B of the pharmaceutical container C relative to the label holder 34 so that the patient label PL does not extend across the preexisting label gap G when the patient label is applied on the container body. The container transporter 22 orients the preexisting label L on the container body B of the pharmaceutical container C relative to the label holder 34 so that the patient label PL is applied over the preexisting label of the pharmaceutical container. In the illustrated embodiment, the container transporter 22 orients the preexisting label L of the pharmaceutical container C by rotating (broadly, moving) the pharmaceutical container relative to the label holder 34 via the rotational joint 25.

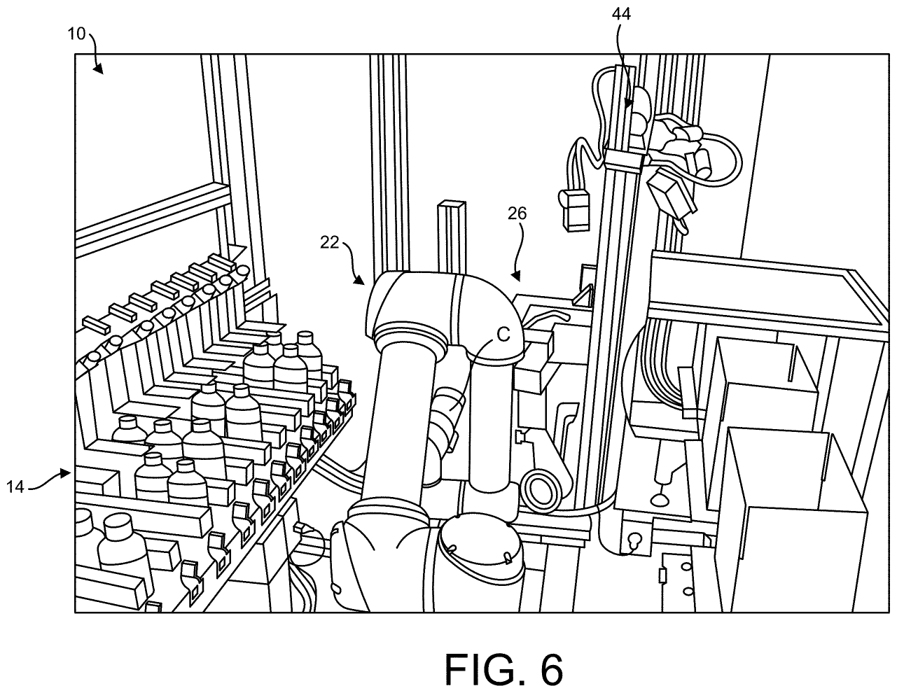

In the illustrated embodiment, the container transporter 22 moves the pharmaceutical container C to a position where it can be scanned by the container identifier 28 and the label detector 30, as shown in FIG. 6. In this position, the container transporter 22 rotates the pharmaceutical container C so that the label detector 30 can detect a side edge E of the preexisting label L. At the same time, the container identifier 28 may scan the preexisting label L to confirm the correct pharmaceutical container was picked from the container repository. The orientation of the pharmaceutical container C the label detector 30 detects the side edge E of the preexisting label L is called the detected or first orientation. In one embodiment, the label detector 30 is arranged relative to the label holder 34 such that when the label detector 30 detects the side edge E of the preexisting label (broadly, detects the preexisting label), the pharmaceutical container C is then also in a correct or application orientation (e.g., rotational orientation) relative to the labeler 26 (e.g., the patient label PL held by the label holder 34) such that the patient label PL can be applied to the pharmaceutical container without any additional rotation (broadly, any additional orienting of the pharmaceutical container relative to the patient label). In other words, in this embodiment, the container transporter 22 maintains the pharmaceutical container C in the detected orientation until the patient label PL is applied (i.e., the detected orientation and the application orientation are the same). The application or second orientation is the orientation of the pharmaceutical container C needed so that the patient label PL is applied on the container body B of the pharmaceutical container C so that at least a portion of the preexisting label gap G is uncovered by the patient label. Thus, in this embodiment, the label detector 30 detects when the pharmaceutical container C is in the application orientation. In another embodiment, when the label detector 30 detects the side edge E of the preexisting label, the pharmaceutical container C is not in the application orientation (i.e., the detected orientation and the application orientation are different). In this case, the container transport 22 rotates the pharmaceutical container C a predetermined amount to place the pharmaceutical container in the application orientation. The predetermined amount is determined based on the size of the pharmaceutical container and size of the preexisting label L, both of which are known based on the type of pharmaceutical container selected. Thus, the container transporter 22 rotates the pharmaceutical container C to orient the preexisting label L relative to the labeler 26 (in particular, the label holder 34 or, more particularly, the patient label PL) so that the patient label can be applied generally over the preexisting label L. Accordingly, in this embodiment, the container transporter 22 rotates the pharmaceutical container C (by the predetermined distance) to orient the preexisting label L relative to the labeler 26 (e.g., label holder 34) based on the detected position of the preexisting label by the label detector 30. It is understood, that for some types of pharmaceutical containers C processed by the system 10 the application and detection orientations will be the same (requiring no further rotation by the container transporter 22 after the label is detected) and that for other types of pharmaceutical containers processed by the system 10 the application and detection orientations will be different (requiring rotation (broadly, orientation) by the container transporter by the predetermined amount). The system 10 may easily switch between these situations based on the type of pharmaceutical container C being processed.

Before, during or after the container transporter 22 places the pharmaceutical container C in the application orientation, the patient label P is prepared. The printer 32 prints the patient label PL. After, with the label holder 34 in the pick position, the label pusher 38 moves the patient label PL toward the label holder 34 which holds the patient label (e.g., the negative pressure source 50 turns on or is already running to provide the suction to hold the patient label). After, the label holder 34 and the patient label PL are moved to the application position. To move to the application position, the first prime mover 40 moves the label holder 34 and patient label PL upward, thereby removing the backing from the underside of the patient label. Then the second prime mover 42 moves the label holder 34 and the patient label PL forward, thereby positioning the label holder and the patient label in the application position. The labeler 26 may include a patient label sensor (not shown) that scans or reads the patient label P to ensure the correct patient label was printed and will be applied to the pharmaceutical container C. In one embodiment, the patient label sensor is arranged to scan the patient label PL when the patient label is in the application position.

After the label holder 34 and the patient label PL are in the application position, the container transporter 22 moves the pharmaceutical container C (which is in application orientation or in the process of moving toward the application orientation) into engagement with the patient label PL. The pressure sensitive adhesive of the patient label PL engages and secures the patient label to the container body B. The label holder 34 then releases the patient label PL (e.g., the negative pressure source 50 is turned off of the flow is interrupted to end the suction). The label holder 34 then returns to the pick position. The container transport 22 moves the pharmaceutical container upward between the brushes 36, which pushes the patient label PL (e.g., edges thereof) down around the container body B. The container transporter 22 then moves the pharmaceutical container C to the next station.

While the label holder 34, label detector 30, and container transporter 22 are implemented in relation to system 10 illustrated in FIGS. 2-7, and 9 of the present disclosure, it is understood that these components may be implemented in other manners and/or have other configurations, in other container processing systems. Such differences in implementation and/or configuration are within the scope of the present disclosure.

As mentioned above, the system 10 can process both round and square pharmaceutical containers C. In general, the process of detecting the position of the preexisting label L only occurs for the round pharmaceutical containers C. This is because the round pharmaceutical containers C can rotate within the channels 16 of the container repository 14. As a result, the relative positions of the preexisting labels L of the round pharmaceutical containers C are not all uniform within a channel 16. Accordingly, the position of the preexisting label L on round pharmaceutical containers C is generally unknown when the pharmaceutical container is removed from the container repository 14. Therefore, the position of the preexisting label L must be determined, as explained above, in order to correctly apply the patient label PL to generally maintain the preexisting label gap G. However, such a problem does not exist for square pharmaceutical containers C. Square pharmaceutical containers C are able to keep their orientation in the channels 16. As a result, the relative positions of the preexisting labels L of the square pharmaceutical containers are uniform. Accordingly, by placing the square pharmaceutical containers C in a specific orientation when the containers are loaded into the channel 16, the position of the preexisting label L on square pharmaceutical containers are known when the pharmaceutical container is removed from the container repository 14. In other words, the orientation of the square pharmaceutical containers C is known such that they system 10 already knows what (if any) amount the square pharmaceutical containers need to be rotated by the container transporter 22 in order to position the square pharmaceutical containers in the application orientation. Accordingly, the labeler 26 does not need to determine the position of the preexisting label L on square pharmaceutical containers C before the patient label PL is applied. The application of the patient label PL for square pharmaceutical containers C is generally the same as round pharmaceutical containers except for the detecting the preexisting label L with the label detector 30 (skipped for the square pharmaceutical containers). However, it is understood the position of the preexisting label L on the square pharmaceutical containers C can still be determined as described above.

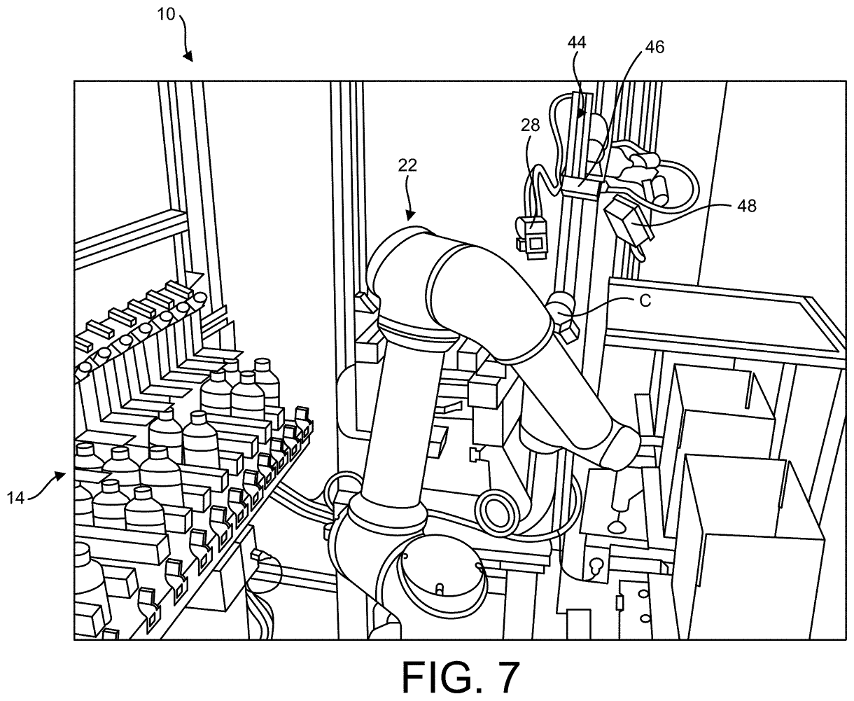

Referring to FIG. 7, the system 10 includes an identification system 44 at the identification station (e.g., the identification system defines the identification station). The container transporter 22 moves the pharmaceutical container C from the labeler 26 to the identification system 44. The identification system 44 is configured to identify the pharmaceutical container C. Specifically, the identification system 44 is arranged to identify the pharmaceutical container C after the patient label PL has been applied by the labeler 26. This way the system 10 can confirm the correct patient label PL was applied to the pharmaceutical container C and that the applied patient label PL was applied correctly (e.g., is readable). The identification system 44 includes a container identifier 28 (e.g., a second container identifier), as generally described above. The identification system 44 may also include a camera 46 for taking a picture of the patient label PL on the pharmaceutical container C and a flash 48 for illuminating the patient label while the picture is taken with the camera. The picture may be saved for record keeping purposes. The identification system 44 may also include an imager, such as an infrared imager, broad-spectrum light imager, radar imager, sonar imager, and the like, for sensing the level of material or items (e.g., pharmaceutical) through the gap in the patient label PL. In one embodiment, the identification system 44 may also image the patient label PL and the gap G to ensure that the patient label was applied accurately and does not cover the gap. In this embodiment, the identification system 44 may include a label detector, such as a contrast sensor, as described above, or the camera 46 may be used, or another type of imager can be used to verify the gap G is present.

After the identification system 44 is finished, the container transporter 22 moves the pharmaceutical container C to the dispensing station where the container transporter releases the pharmaceutical container. Any number of different components may be at the dispensing station. For example, in the illustrated embedment, a box carried by a conveyor is located at the dispensing station and the container transporter places the pharmaceutical container C in the box. In other embodiments, a bagger (not shown) may be disposed at the dispensing station for bagging or packaging the pharmaceutical container C in a shipping bag or package. Other components may be disposed at the dispensing station for receiving the pharmaceutical container C from the container transporter 22. In one embodiment, the dispensing station includes a camera arranged to take a picture of the pharmaceutical container C in the box. This image can be saved for record keeping purposes to establish that the pharmaceutical container C was present in the box when the box was shipped.

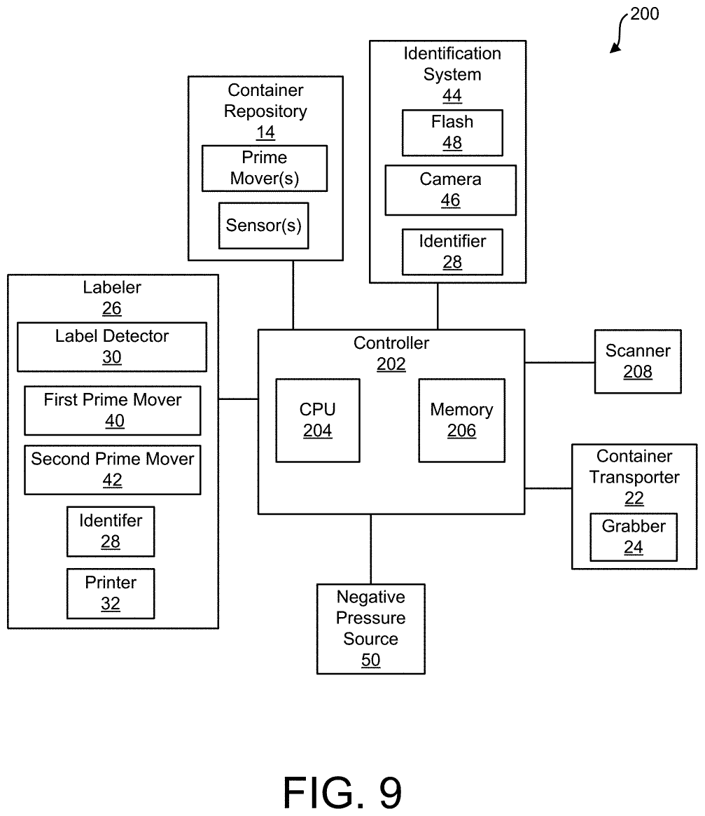

Referring to FIG. 9, an example control system (e.g. pharmaceutical container processing control system) of the system 10 is generally indicated by reference numeral 200. The control system 200 includes a controller 202 (broadly, a computer) for controlling and operating the system 10 and its components. The controller 202 (e.g., pharmaceutical container processing controller) includes a CPU or processor 204 (e.g., a pharmaceutical order processing system processor) and RAM or memory 206 (broadly, non-transitory computer readable storage medium). The controller 202 directs (e.g., controls and operates) the various components (e.g., the container repository 14, the container transporter 22, the labeler 26, etc.) and sub-components (e.g., prime movers, printer 32, etc.) thereof. Broadly, the memory 206 includes (e.g., stores) processor-executable instructions for controlling the operation of the system 10 and the components thereof. The instructions embody one or more functional aspects of the system 10 and components thereof (as described herein), with the processor 202 executing the instructions to perform said one or more functional aspects. The components of the system 10 may be in wired or wireless communication with the controller 202. The controller 202 may be a dedicated controller for the system 10 that is in communication with a control system of the pharmacy or part of the control system of the pharmacy. Other configurations of the control system 200 are within the scope of the present disclosure.

The controller 202 is communicatively coupled to the various components of the system 10 to control and/or operate these components. The controller 202 is configured to receive or access a prescription order for a patient and to direct (e.g., operate), as described herein, the system 10 to fulfill the prescription order (e.g., prepare the one or more pharmaceutical containers C that the prescription order calls for). In the illustrated embodiment, the system 10 may include a scanner 208 that scans a machine readable marking or identification tag (e.g., RFID) on the box or conveyor to obtain a code (e.g., order number). Once the controller 202 has the code, the controller may associate the code with a prescription order and identify what pharmaceutical containers C are required to fulfill the prescription order associated with the code. The controller 202 can then operate the system 10 to select the appropriate pharmaceutical container(s) C and have the appropriate patient label(s) PL printed. For example, the controller 202 can operate the container transporter 22 to pick an appropriate pharmaceutical container C from the container repository 14. In another example, the controller 202 can receive identifying information (e.g., a serial number) of the pharmaceutical container C from the container identifier 28 of the labeler 26 and compare the identifying information to the prescription order to verify whether or not the correct pharmaceutical container was selected from the container repository 14 by the container transporter 22. If the wrong pharmaceutical container C was picked, the controller 202 may instruct the container transporter 22 to move the pharmaceutical container an alternative location (e.g., a removal location) due to the pharmaceutical container not being the correct type for the pharmaceutical order. The controller 202 may also provide information (e.g., patient name, prescription information, etc.) to the labeler 26 for the creation of the patient label PL by the printer 32 for the pharmaceutical container C. The controller 202 may also identify the type (e.g., round or rectangular) the pharmaceutical container C being picked based on the prescription order. The controller 202 may also receive label position and/or orientation information from the label detector 30 and operate the container transporter 22 accordingly to keep the pharmaceutical container in the application orientation (e.g., stop the rotation of the pharmaceutical container by the container transporter) or rotate the pharmaceutical container by the predetermined amount to the application orientation. Accordingly, it is understood the controller 202 directs the components of the system 10 as necessary to perform the functions described herein.

Other types of information can also be shared between the controller 202 and the components of the system 10. For example, the controller 202 can send the location of a particular type of pharmaceutical container C on the container repository 14 to the container transporter 22. In this embodiment, the location of the pharmaceutical container C may be obtained by a user input device (not shown) communicatively coupled to the controller 202 or by an identification sensor (e.g., scanner) (not shown) communicatively coupled to the controller 202.

The presently described systems and methods to automate re-labeling containers can be used in various production environments. Some of these environments are described in U.S. patent application Ser. Nos. 17/973,879 and 17/973,829, which are hereby incorporated by reference in their entireties. The present re-labeling can be part of the product packaging systems and tracked in the load balancing system in these applications.

Although described in connection with an example computing system environment, embodiments of the aspects of the disclosure are operational with numerous other general purpose or special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the example operating environment. Examples of well-known computing systems, computing circuitry, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers, which include computing circuitry, may execute the processor-executable instructions (e.g., software, firmware, and/or hardware) such as those illustrated herein to implement aspects of the disclosure.

Embodiments of the aspects of the disclosure may be implemented with processor-executable instructions. The processor-executable instructions may be organized into one or more processor-executable components or modules on a tangible processor readable storage medium. Aspects of the disclosure may be implemented with any number and organization of such components or modules. For example, aspects of the disclosure are not limited to the specific processor-executable instructions or the specific components or modules illustrated in the figures and described herein. Other embodiments of the aspects of the disclosure may include different processor-executable instructions or components having more or less functionality than illustrated and described herein.

The order of execution or performance of the operations in embodiments of the aspects of the disclosure illustrated and described herein is not essential, unless otherwise specified. That is, the operations may be performed in any order, unless otherwise specified, and embodiments of the aspects of the disclosure may include additional or fewer operations than those disclosed herein. For example, it is contemplated that executing or performing a particular operation before, contemporaneously with, or after another operation is within the scope of aspects of the disclosure.

It is apparent that the elements, features, and/or teachings set forth in each embodiment disclosed herein are not limited to the specific embodiment(s) in which the elements, features and/or teachings are explicitly described. Accordingly, it is understood that the elements, features and/or teachings described in one embodiment may be applied to one or more of the other embodiments disclosed herein, even if said elements, features and/or teachings where not described herein as being a part of said one or more of the other embodiments.

The Title, Field, and Background are provided to help the reader quickly ascertain the nature of the technical disclosure. They are submitted with the understanding that they will not be used to interpret or limit the scope or meaning of the claims. They are provided to introduce a selection of concepts in simplified form that are further described in the Detailed Description. The Title, Field, and Background are not intended to identify key features or essential features of the claimed subject matter, nor is it intended to be used as an aid in determining the claimed subject matter.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the disclosure are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the disclosure by way of example and not by way of limitation. This description enables one skilled in the art to make and use the aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure is not limited in its application to the details of construction and the arrangement of components set forth in the description or illustrated in the drawings. The aspects of the disclosure are capable of other embodiments and of being practiced or carried out in various ways. Also, it will be understood that the phraseology and terminology used herein is for the purpose of description and should not be regarded as limiting.

Having described aspects of the disclosure in detail, it will be apparent that modifications and variations are possible without departing from the scope of aspects of the disclosure as defined in the appended claims. It is contemplated that various changes could be made in the above constructions, products, and methods without departing from the scope of aspects of the disclosure. In the preceding specification, various embodiments have been described with reference to the accompanying drawings. It will, however, be evident that various modifications and changes may be made thereto, and additional embodiments may be implemented, without departing from the broader scope of the aspects of the disclosure as set forth in the claims that follow. The specification and drawings are accordingly to be regarded in an illustrative rather than restrictive sense.

What is claimed is:

1. A pharmaceutical container processor for processing a pharmaceutical container, the pharmaceutical container including a container body and a preexisting label on the container body, the preexisting label having opposite side edges defining a preexisting label gap therebetween, the pharmaceutical container processor comprising:
a label holder configured to position a patient label to be applied on the container body of the pharmaceutical container;
a label detector configured to detect the preexisting label on the container body; and
a container transporter configured to orient the preexisting label on the container body of the pharmaceutical container relative to the label holder so that at least a portion of the preexisting label gap is uncovered by the patient label when the patient label is applied on the container body.

2. The pharmaceutical container processor of claim 1, wherein the container transporter is configured to orient the preexisting label on the container body of the pharmaceutical container relative to the label holder so that the entirety of the preexisting label gap is uncovered by the patient label when the patient label is applied on the container body.

3. The pharmaceutical container processor of claim 1, wherein the container transporter is configured to orient the preexisting label on the container body of the pharmaceutical container relative to the label holder so that the patient label does not extend across the preexisting label gap when the patient label is applied on the container body.

4. The pharmaceutical container processor of claim 1, wherein the container transporter is configured to orient the preexisting label on the container body of the pharmaceutical container relative to the label holder so that the patient label is applied over the preexisting label of the pharmaceutical container.

5. The pharmaceutical container processor of claim 4, wherein the label detector includes a label orientation sensor configured to detect the orientation of the preexisting label of the pharmaceutical container.

6. The pharmaceutical container processor of claim 5, wherein the label orientation sensor comprises a contrast sensor.

7. The pharmaceutical container processor of claim 5, wherein the label detector is configured to detect the orientation of the preexisting label relative to the label holder.

8. The pharmaceutical container processor of claim 1, wherein the container transporter is configured to rotate the pharmaceutical container to orient the preexisting label of the pharmaceutical container relative to the label holder.

9. The pharmaceutical container processor of claim 8, wherein the label detector is configured to detect the orientation of the preexisting label of the pharmaceutical container, the container transporter being configured to rotate the pharmaceutical container to orient the preexisting label of the pharmaceutical container relative to the label holder based on a detected orientation of the preexisting label by the label detector.

10. The pharmaceutical container processor of claim 1, wherein the label detector is arranged relative to the label holder such that, when the label detector detects the preexisting label, the preexisting label is in an orientation relative to the label holder in which said at least a portion of the preexisting label gap will be uncovered by the patient label when the patient label is applied on the container body.

11. The pharmaceutical container processor of claim 10, further comprising a labeler configured to apply the patient label on the container body of the pharmaceutical container, the labeler including the label holder.

12. A method of processing a pharmaceutical container, the method comprising:
orienting the pharmaceutical container and a patient label relative to one another, the pharmaceutical container including a container body and a preexisting label on the container body, the preexisting label having opposite side edges defining a preexisting label gap therebetween; and
applying the patient label on the container body of the pharmaceutical container so that at least a portion of the preexisting label gap is uncovered by the patient label.

13. The method of claim 12, further comprising determining the position of the preexisting label of the pharmaceutical container.

14. The method of claim 13, wherein said determining includes detecting the preexisting label with a label orientation sensor.

15. The method of claim 14, wherein said detecting includes detecting an edge of the preexisting label with the label orientation sensor.

16. The method of claim 14, wherein the label orientation sensor comprises a contrast sensor.

17. The method of claim 13, further comprising orienting the pharmaceutical container relative to the patient label after said determining so that the patient label can be applied generally over the preexisting label.

18. The method of claim 12, wherein said applying includes applying the patient label on the container body of the pharmaceutical container so that the entirety of the preexisting label gap is uncovered by the patient label.

19. The method of claim 12, wherein said applying includes applying the patient label on the container body of the pharmaceutical container so that the patient label does not extend across the preexisting label gap.

20. The method of claim 12, wherein said applying includes applying the patient label over the preexisting label of the pharmaceutical container.
